(19) United States
(12) Patent Application Publication
(10) Pub. No.: US 2024/0284434 A1
(43) Pub. Date: Aug. 22, 2024

(54) TECHNOLOGIES FOR ASSOCIATING TRANSMISSION CONFIGURATION INDICATOR STATES WITH UPLINK AND DOWNLINK CHANNELS

(71) Applicant: Apple Inc., Cupertino, CA (US)

(72) Inventors: Hong He, San Jose, CA (US); Ankit Bhamri, Haar (DE); Chunxuan Ye, San Diego, CA (US); Dawei Zhang, Saratoga, CA (US); Wei Zeng, Saratoga, CA (US); Weidong Yang, San Diego, CA (US)

(73) Assignee: Apple Inc., Cupertino, CA (US)

(21) Appl. No.: 18/414,390

(22) Filed: Jan. 16, 2024

Related U.S. Application Data
(60) Provisional application No. 63/446,290, filed on Feb. 16, 2023.

(51) Int. Cl. H04W 72/11; H04W 72/232

(52) U.S. Cl. CPC H04W 72/11; H04W 72/232

(57) ABSTRACT

The present application relates to devices and components including apparatus, systems, and methods for unified transmission configuration indicator state for multiple-transmit-receive point operation in wireless networks.

### CROSS-REFERENCES TO RELATED APPLICATION

This application claims the benefit of U.S. Provisional Patent Application No. 63/446,290, filed Feb. 16, 2023. The disclosure of this application is incorporated by reference herein in its entirety.

### TECHNICAL FIELD

This application relates generally to communication networks and, in particular, to technologies for associating transmission configuration indicator (TCI) states with uplink and downlink channels in wireless networks.

### BACKGROUND

Third Generation Partnership Project (3GPP) Technical Specifications (TSs) provide details of radio interface protocols to facilitate communication over wireless networks. These TSs define mTRP operation in which a serving cell communicates with a user equipment (UE) using two or more transmit-receive points (TRPs). This may improve coverage, reliability, or data rates. Further improvements in mTRP operation is desired.

### BRIEF DESCRIPTION OF THE DRAWINGS

FIG. 1 illustrates a network environment in accordance with some embodiments.

FIG. 2 illustrates transmission configuration indicator (TCI) configuration and signaling in accordance with some embodiments.

FIG. 3 illustrates transmission scenarios in accordance with some embodiments.

FIG. 4 illustrates TCI state mappings in accordance with some embodiments.

FIG. 5 illustrates an operating mode table in accordance with some embodiments.

FIG. 6 illustrates a network environment in accordance with some embodiments.

FIG. 7 illustrates an operational flow/algorithmic structure in accordance with some embodiments.

FIG. 8 illustrates another operational flow/algorithmic structure in accordance with some embodiments.

FIG. 9 illustrates another operational flow/algorithmic structure in accordance with some embodiments.

FIG. 10 illustrates a user equipment in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The terms “multi,” “multiple,” “plurality,” and the like as used herein refer to more than one item, instance, or event.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

3GPP TSs describe operations that rely on transmission configuration indicator (TCI) states to facilitate communications. A TCI state may define a quasi-co-location (QCL) relationship between a source and a target. The source and target may be reference signals such as, for example, a synchronization signal block (SSB), a channel state information—reference signal (CSI-RS) (for beam management or channel quality indicator (CQI) measurement), a sounding reference signal (SRS), or a demodulation reference signal (DMRS). Channel properties (for example, spatial, time, or frequency domain properties) determined for the source may be inferred with respect to the target. Different QCL types indicate different channel properties may be inferred. For example, QCL Type A corresponds to Doppler shift, Doppler Spread, average delay, and delay spread; QCL Type B corresponds to Doppler shift and Doppler spread; QCL Type C corresponds to Doppler shift and average delay; and QCL Type D corresponds to a spatial Rx parameter.

3GPP Release 17 (R17) introduced a unified TCI framework for single TRP operation. The unified TCI state may refer to a TCI state that applies to multiple downlink or uplink channels. For example, a unified downlink (DL) TCI state may be applied to both a downlink data channel (e.g., a physical downlink shared channel (PDSCH)) and a downlink control channel (e.g., a physical downlink control channel (PDCCH), while a unified uplink (UL) TCI state may be applied to both an uplink data channel (e.g., a PUSCH) and an uplink control channel (e.g., PUCCH). The R17 unified TCI state supports two modes. In a first mode, a joint unified TCI state is applicable to both uplink and downlink channels. In a second mode, a DL TCI state is used for downlink channels and a separate UL TCI state is used for uplink channels.

To support the two modes of R17, RRC signaling may be used to configure a UE with a pool of unified TCI states by signaling one or two lists. If only one list is used to configure the pool, the list will be a DL-or-joint-TCI-state list (dl-OrJoint-TCIStateList) having TCI states that will be used as joint unified TCI states. If two lists are used to configure the pool, the first list (dl-OrJoint-TCIStateList) will provide unified DL TCI states and a second list, UL TCI state list (ul-TCI-StateList), will provide unified UL TCI states.

In the R17 unified TCI framework, the TCI states of a configured pool may be indicated/activated in one of two ways. In a first way, a MAC control element (CE) is used to indicate either a joint unified TCI state of the configured pool, or to indicate one unified DL TCI state and one unified DL TCI state. In a second way, the MAC CE may activate a plurality of joint unified TCI states or a plurality of sets of unified UL/DL TCI states. Subsequently, DCI may be used to indicate one of the activated TCI/TCI sets that is to be used.

The R17 unified TCI framework that is designed to support a situation in which all uplink and downlink signals/channels are received/transmitted using the same beam (e.g., TCI state). It also provides support for the case in which all downlink signals are received in one beam and all uplink signals are transmitted in one beam. These limitations of the R17 unified TCI framework inhibit support for multi-TRP (mTRP) operation.

Embodiments address various issues that may occur from extending the unified TCI framework from single-TRP (sTRP) to mTRP. Some embodiments describe how to associate indicated TCI states to semi-persistent scheduling (SPS) PDSCH. These embodiments may describe UE behavior when unified TCI states are updated from two to one for different mTRP schemes including spatial division multiplexing (SDM), frequency division multiplexing (FDM) (both schemes A and B), and time division multiplexing (TDM) (both schemes A and B). Additional embodiments describe how to indicate unified TCI state for Type-1 and Type-2 configured grant (CG) PUSCH. Some aspects of these embodiments may define UE behavior when TCI states are updated from two to one for different mTRP schemes such as, for example, simultaneous transmission over multiple panels (STxMP) and repetition switches (as introduced in R17). Still further embodiments describe how to determine a TCI state for CG or dynamic grant (DG) PUSCH scheduled by fallback DCI 1_0 without an indicator field.

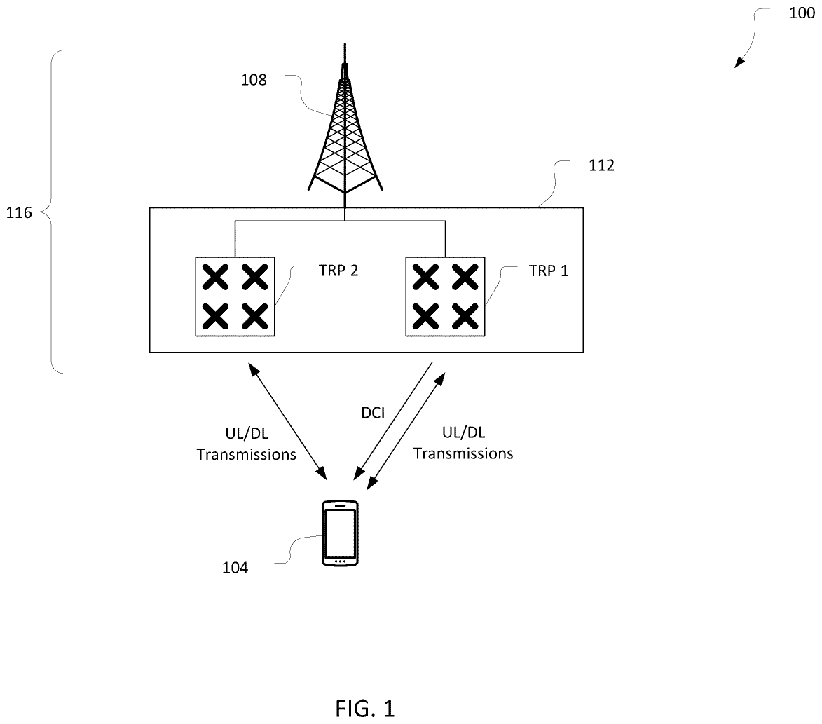

FIG. 1 illustrates a network environment 100 in accordance with some embodiments. The network environment 100 may include a UE 104 and a base station 108. The base station 108 may be coupled with a plurality of TRPs 112 to provide one or more wireless access cells through which the UE 104 may communicate. As shown, the base station 108 may be coupled with two TRPs 112, e.g., TRP 1 and TRP 2. The base station 108 may use the TRPs 112 to provide geographically distributed points of transmission/reception to increase cell coverage and spatial diversity. Each of the TRPs may include a single TRP or a group of TRPs that are generally controlled as a single TRP.

While FIG. 1 illustrates the base station 108 coupled with the two TRPs directly, in other embodiments, more than one base station may be coupled with the two TRPs and the base stations may communicate with one other over a backhaul link to coordinate communications with the UE 104. The base station 108 and TRPs 112 may be collectively referred to as an access node 116.

The access node 116 may provide an air interface compatible with 3GPP technical specifications, such as those that define Fifth Generation (5G) new radio (NR) or later system standards. Depending on the technology, the base station 108 may be referred to as an eNB, gNB, an ng-NB, etc. The access node 116 may provide the UE 104 access to other networks, for example, a core network, a data network, etc.

The access node 116 may control the uplink and downlink operation through the physical (PHY) layer and media access control (MAC) layer. The configuration information may be provided to the UE 104 by the RRC layer.

In some embodiments, the access node 116 may perform single-DCI mTRP operation in which a single DCI is used to schedule uplink or downlink transmissions with respect to more than one TRP. For example, as shown, TRP 1 may send DCI to the UE 104 that schedules uplink/downlink channel transmissions with respect to both the TRP 1 and the TRP 2.

Embodiments of the present disclosure describe aspects that provide for two unified TCI states to be activated/indicated for single-DCI mTRP operation with respect to uplink/downlink transmissions including SPS-PDSCH transmissions, CG-PUSCH transmission (Type 1 and Type 2), DG-PUSCH transmissions, and PUSCH transmissions scheduled with fallback DCI.

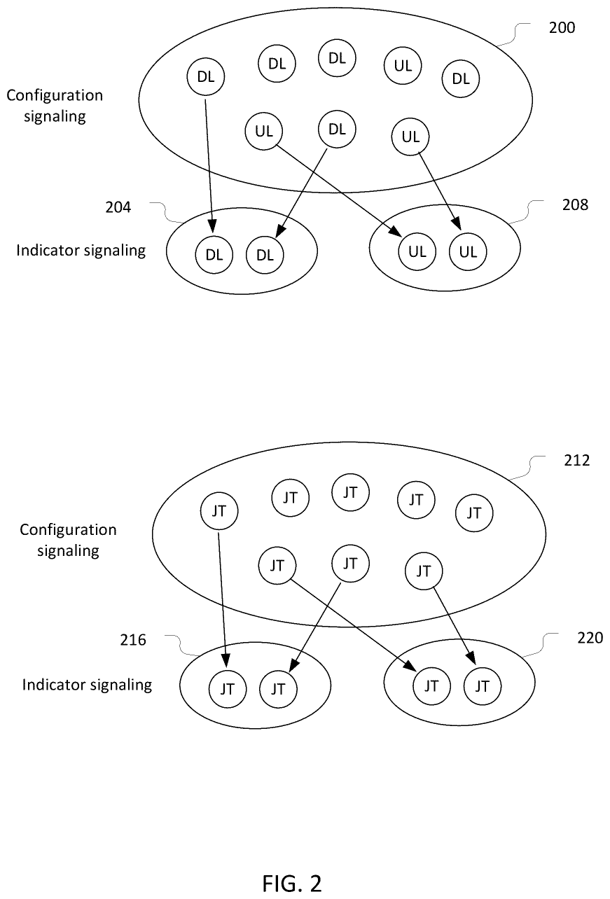

FIG. 2 illustrates TCI configuration and signaling aspects in accordance with some embodiments.

In some embodiments, configuration signaling may be used to configure a TCI state pool 200. The configuration signaling may include RRC signaling that provides two TCI state lists (e.g., dl-OrJoint-TCIStateList and ul-TCIStateList). The TCI states from the dl-OrJoint-TCIStateList may provide the DL TCI states of the TCI state pool 200, and the TCI states from the ul-TCIStateList may provide the UL TCI states of the TCI state pool 200. Indicator signaling may then be used to associate one or two TCI states, from the TCI state pool 200, with an UL or DL channel. For example, as shown, the indicator signaling may provide a first association 204 that associates two DL TCI states with a DL channel. Indicator signaling may also be used to provide a second association 208 that associates two UL TCI states with an UL channel. The indicator signaling may be MAC-CE-based indicator signaling or MAC-CE+DCI-based indicator signaling.

In some embodiments, configuration signaling may be used to configure a TCI state pool 212. The configuration signaling may include RRC signaling that provides one TCI state list (e.g., dl-OrJoint-TCIStateList). The TCI states from the dl-OrJoint-TCIStateList may provide the joint (JT) TCI states of the TCI state pool 212. Indicator signaling may then be used to associate one or two TCI states, from the TCI state pool 212, with an UL or DL channel. For example, as shown, the indicator signaling may provide a first association 216 that associates two JT TCI states with a DL channel. Indicator signaling may also be used to provide a second association 220 that associates two JT TCI states with an UL channel. The indicator signaling may be MAC-CE-based indicator signaling or MAC-CE+DCI-based indicator signaling.

Two TCI states may be associated with a channel to facilitate mTRP operation. For example, a first TCI state may be used for communications to/from a first TRP while a second TCI state may be used for communications to/from a second TRP.

In some embodiments, two unified TCI states may be associated with an SPS PDSCH. The two unified TCI states may include unified DL TCI states or joint unified TCI states. The UE 104 may determine how to use the two unified TCI states to receive an SPS-PDSCH transmission according to one or more of the following options.

In a first option, a mode indicator may be added into an SPS-configuration information element (IE) that configures resources for the SPS PDSCH. The mode indicator may be a two-bit indicator that indicates an operating mode for the UE 104. The operating mode may be a first operating mode in which the UE 104 receives the SPS PDSCH transmission using a first TCI state of the two unified TCI states; a second operating mode in which the UE receives the SPS PDSCH transmission using a second TCI state of the two unified TCI states; or a third operating mode in which the UE 104 receives the SPS PDSCH transmission using both the first TCI state and the second TCI state. In the third operating mode, SPS PDSCH may be configured for spatial, time, or frequency repetition in which case the first TCI state is used for a first repetition and the second TCI state is used for a second repetition. This pattern may repeat for subsequent repetitions. As used herein, a repetition may refer to a transmission that will be transmitted more than once. Thus, the first transmission instance may be referred to as a repetition, even if it is not yet repeated at the time of transmission.

The first two operating modes may be referred to as sTRP operating modes and the third operating mode may be referred to as a mTRP operating mode. In some embodiments, another mTRP operating mode may be signaled by the two-bit indicator in which the order of using the TCI states is reversed. For example, in a fourth operating mode, the UE 104 may use the second TCI state to receive a first repetition of the SPS PDSCH transmission and use the first TCI state to receive the second repetition of the SPS PDSCH transmission. This pattern may repeat for subsequent repetitions.

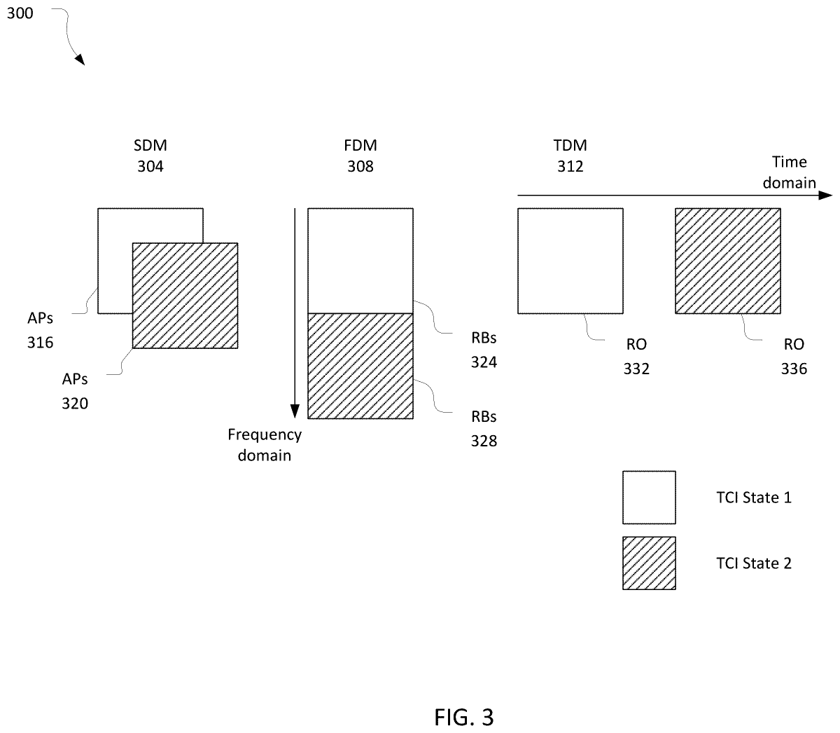

FIG. 3 illustrates transmission scenarios in accordance with some embodiments. In particular, FIG. 3 illustrates transmissions of repetitions of an SPS-PDSCH transmission using spatial-division multiplexing (SDM) 304, frequency-division multiplexing (FDM) 308, or time-division multiplexing (TDM) 312.

In SDM 304, a first repetition may be transmitted using one or more first antenna ports (APs) 316 with a first TCI state, while a second repetition may be transmitted using one or more second APs 320 with the second TCI state. Thus, in SDM 304, the repetitions may be spread across a spatial domain.

In FDM 308, a first repetition may be transmitted using one or more first resource blocks (RBs) 324 with a first TCI state, while a second repetition may be transmitted using one or more second RBs 328 with the second TCI state. Thus, in FDM 308, the repetitions may be spread across a frequency domain. FDM 308 may be FDM scheme A, in which a single redundancy version (RV) is included in a slot, or FDM scheme B, in which an RV pair is in a slot.

In TDM 312, a first repetition may be transmitted in a first reception occasion (RO) 332 with a first TCI state, while a second repetition may be transmitted in a second RO 336 with the second TCI state. Thus, in TDM 312, the repetitions may be spread across a time domain. TDM 312 may be TDM scheme A, in which an RV pair is included in an RO (e.g., a slot), or an inter-slot TDM scheme in which a single RV is in an RO (e.g., a slot).

In a second option for receiving SPS-PDSCH transmissions, the mode indicator may be specified by DCI used for SPS activation. This DCI, which may also be referred to as “activation DCI,” may have cyclic redundancy check (CRC) bits scrambled by a configured scheduling-radio network temporary identifier (CS-RNTI).

The mode indicator may include two bits that indicates one of the three or four operating modes discussed above with respect to the first option.

In the event the activation DCI is DCI format 1_0, the mode-indicator field may be created by repurposing two reserved bits (R) of the DCI as currently defined by clause 7.3.1.2.1 of 3GPP TS 38.212 v17.4.0 (2023-01-04).

In the event the activation DCI is DCI format 1_1, the mode-indicator field may be created by adding a new mode-indicator field as it is transmitted in a UE-specific search space (USS). Additionally/alternatively, the mode-indicator field may be created by repurposing two validation bits of the DCI as currently defined by clause 7.3.1.2.2 of 3GPP TS 38.212 v17.4.0 (2023-01-04). For example, the validation bits may be the two most-significant bits (MSB) from a hybrid automatic repeat request (HARQ) process number or redundancy version (RV) field.

In some embodiments, the number of joint/DL unified TCI states may be updated from two to one. For example, indicator signaling may originally provide an association of two joint/DL unified TCI states to an SPS PDSCH and, at a later time, indicator signaling may update the association in a manner such that a single joint/DL unified TCI state is associated with the SPS PDSCH. The single joint/DL unified TCI state may be one of the two joint DL/TCI states or a different DL/TCI state. In this event, the UE 104 may receive subsequent repetitions of the SPS PDSCH transmission with the single joint/DL unified TCI state in accordance with one or more of the following options. Each of the mTRP schemes described with respect to FIG. 3 may be considered.

In a first option, the single unified TCI state may be applied for receiving all the repetitions of the SPS PDSCH transmission including, for example, the repetition previously associated with the second TCI state. With this option, the SPS-PDSCH reception essentially falls back to an sTRP operating mode.

Consider, for example, that a two-state association associates TCI state 1 with a first repetition and TCI state 2 with a second repetition and a one-state association, with TCI state 3 (which can be one of TCI states 1 or 2 or a different TCI state), is later received. In this embodiment, and with reference to FIG. 3, after the update, both repetitions (on APs 316 and 320 if SDM 304; RBs 324 and RBs 328 if FDM 308; and RO 332 and RO 336 if TDM 312) will be received using TCI state 3.

In a second option, upon receipt of the one-state association, the UE 104 may determine that the SPS PDSCH configuration configured with two joint/DL unified TCI states is deactivated or released implicitly. In this instance, the UE 104 may not monitor the configured SPS PDSCH resources further in anticipation of receiving an updated SPS PDSCH configuration.

In a third option, the PDSCH occasions associated with the second TCI state may be released, disabled, or deactivated. For example, with reference to FIG. 3, the UE 104 may cease to monitor APs 320 for SDM 304, RBs 328 for FDM 308, or RO 336 for TDM 312.

In some embodiments, two unified TCI states may be associated with a CG PUSCH. The two unified TCI states may include unified UL TCI states or joint unified TCI states. The CG PUSCH may be a Type 1 CG or Type 2 CG. Type 1 CG may be fully configured using RRC signaling without requiring DCI. Once the Type 1 CG is configured, the UE 104 may use the resources. Type 2 CG may use a combination of RRC signaling to configure the resources, and DCI to activate them for use by the UE 104.

In some embodiments, when two joint TCI states or two UL TCI states are indicated by a TCI field of the indication signaling, the UE 104 may map the two TCI states to a Type-1 CG-PUSCH transmission according to one or more of the following options.

The UE 104 may operate differently depending on a number of SRS resource sets that are configured in a CG configuration (e.g., a ConfiguredGrantConfig) IE that configures the resources for the Type-1 CG PUSCH. An SRS resource set may be configured by fields such as, for example, a pathloss reference index (pathlossReferencelndex) that indicates the reference signal index used as PUSCH pathloss reference, an SRS resource indicator (srs-Resourcelndicator) that indicates the SRS resource to be used, and a precoding and number of layers (precodingAndNumberofLayers) that indicates the precoding and number of layers to be used. In some embodiments, if the ConfiguredGrantConfig 1E includes fields to configure both a first SRS resource set (e.g., pathlossReferencelndex, srs-ResourceIndicator, and precodingAndNumberofLayers) and a second SRS resource set (e.g., pathlossReferencelndex2, srs-Resourcelndicator2, and precodingAndNumberofLayers), the UE 104 may apply both the first and second TCI states to the Type-1 CG-PUSCH transmission. In particular, the UE 104 may use the first TCI state for PUSCH repetitions associated with the first SRS resource set and may use the second TCI state for PUSCH repetitions associated with the second SRS resource set.

In some embodiments, the SRS resource set that is associated with the relatively smaller identifier may be considered the first SRS resource set and the SRS resource set associated with the relatively larger identifier may be considered the second SRS resource set.

In the event the ConfiguredGrantConfig 1E only includes fields to configure the first SRS resource set (e.g., it has pathlossReferencelndex, srs-Resourcelndicator, and precodingAndNumberofLayers but it does not have pathlossReferencelndex2, srs-Resourcelndicator2, and precodingAndNumberofLayers), only the first TCI state will be associated with the SRS resource set and applied for all the PUSCH repetitions.

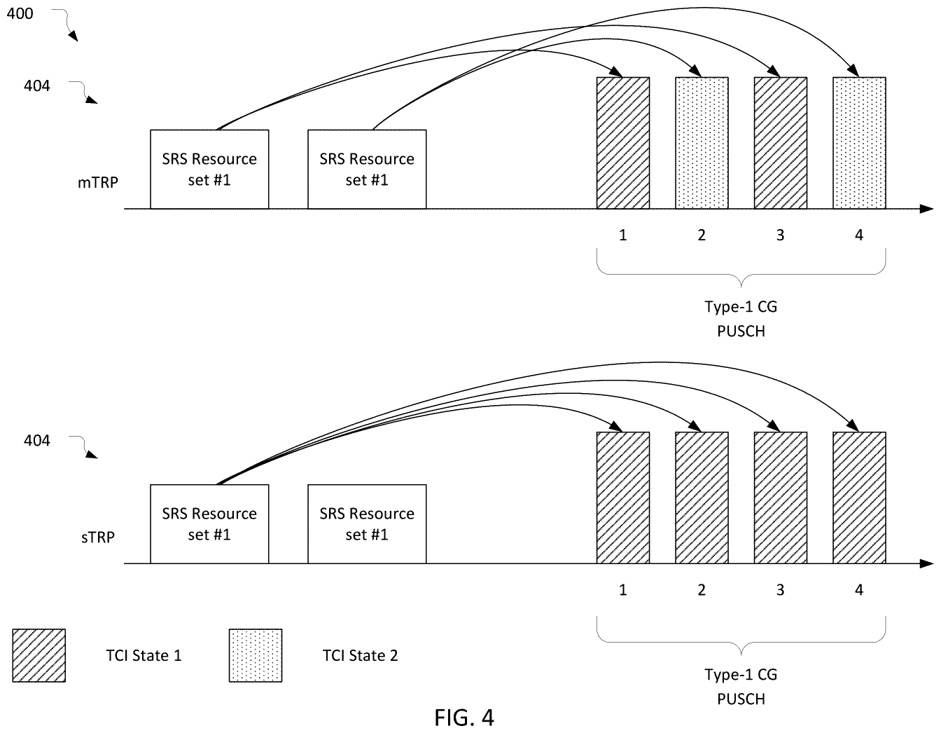

FIG. 4 illustrates TCI state mappings 400 in accordance with some embodiments. For example, if the ConfiguredGrantConfig 1E configures two SRS resource sets, the UE 104 may use mapping 404 in an mTRP operation. The mapping 404 may map SRS resource set #1 to the first and third repetitions of a Type-1 CG PUSCH and may map SRS resource set #2 to the second and fourth repetitions of the Type-1 CG PUSCH. Thus, the odd repetitions (e.g., first, third, etc. repetitions) may be transmitted using TCI state 1 and the even repetitions (e.g., second, fourth, etc. repetitions) may be transmitted using TCI state 2.

If the ConfiguredGrantConfig 1E configures one SRS resource set, the UE 104 may use mapping 408 in an sTRP operation. The mapping 408 may map SRS resource set #1 to all repetitions of the Type-1 CG PUSCH. As SRS resource set #1 is associated with TCI state 1, all repetitions of the Type-1 CG PUSCH may be transmitted using TCI state 1.

In some embodiments, the TCI state that is considered the first TCI state (e.g., TCI state 1) of the two indicated TCI states may be explicitly configured by RRC signaling.

For Type-2 CG PUSCH, the UE 104 may rely on signaling of a mode indicator in the activation DCI. For example, when two joint TCI states or two UL TCI states are indicated by a TCI field of indication signaling, the following procedure may be used to map the two TCI states for a Type-2 CG PUSCH transmission.

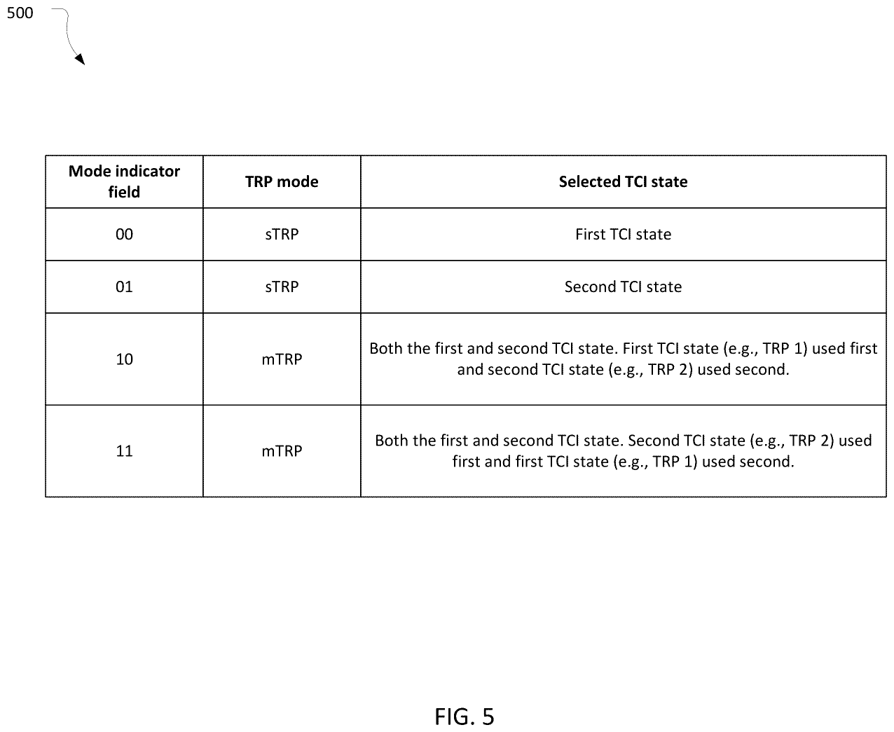

In some embodiments, DCI that activates a Type-2 CG PUSCH may include the mode indicator by repurposing a two-bit SRS resource set indicator. For example, the two-bits used for the SRS resource set indicator in an activation DCI as defined in 3GPP TS 38.212 v17.4.0 (2023-01-04) may instead be used for the two-bit mode indicator. In some embodiments, the two-bit mode indicator may be interpreted based on the operating mode table 500 of FIG. 5 in accordance with some embodiments.

The mode indicator field may include a value of {0, 0} to indicate the UE 104 is to operate in first sTRP mode. In the first sTRP mode, the UE 104 may transmit the Type-2 CG PUSCH transmission using a first TCI state. The first TCI state may correspond to TRP 1.

The mode indicator may include a value of {0, 1} to indicate the UE 104 is to operate in a second sTRP mode. In the second sTRP mode, the UE 104 may transmit the Type-2 CG PUSCH transmission using a second TCI state. The second TCI state may correspond to TRP 2.

In some embodiments, the TCI state of the two indicated TCI states that is considered the “first” TCI state and which is considered the “second” TCI state may be based on a TCI state ordering within a MAC-CE of the indication signaling.

The mode indicator may include a value of {1, 0} to indicate the UE 104 is to operate in a first mTRP mode. In the first mTRP mode, the UE 104 may transmit the Type-2 CG PUSCH transmission using both the first TCI state and the second TCI state. The first TCI state (corresponding to TRP 1, for example) may be used first (e.g., for the first repetition) and the second TCI state (corresponding to TRP 2, for example) may be used second (e.g., for the second repetition).

The mode indicator may include a value of {1, 1} to indicate the UE 104 is to operate in a second mTRP mode. In the second mTRP mode, the UE 104 may also transmit the Type-2 CG PUSCH transmission using both the first TCI state and the second TCI state. However, in this mode, the second TCI state (corresponding to TRP 2, for example) may be used first (e.g., for the first repetition) and the first TCI state (corresponding to TRP 1, for example) may be used second (e.g., for the second repetition).

In some embodiments, when the number of joint or UL unified TCI states associated with a CG PUSCH is updated from two to one by a TCI field in indicator signaling (e.g., a DCI format), one or more of the following options may be used to handle the CG PUSCH that was originally configured or activated with the two TCI states.

For TDM-based repetition as defined in, for example, R17, the single indicated TCI state may be applied to all the PUSCH repetition occasions. Thus, in this instance, upon receiving the association update, the UE 104 may fall back to sTRP operation using the single indicated TCI state.

In some embodiments, the UE 104 may include multiple antenna panels and be configured for CG PUSCH using simultaneous uplink transmission across multiple panels (STxMP).

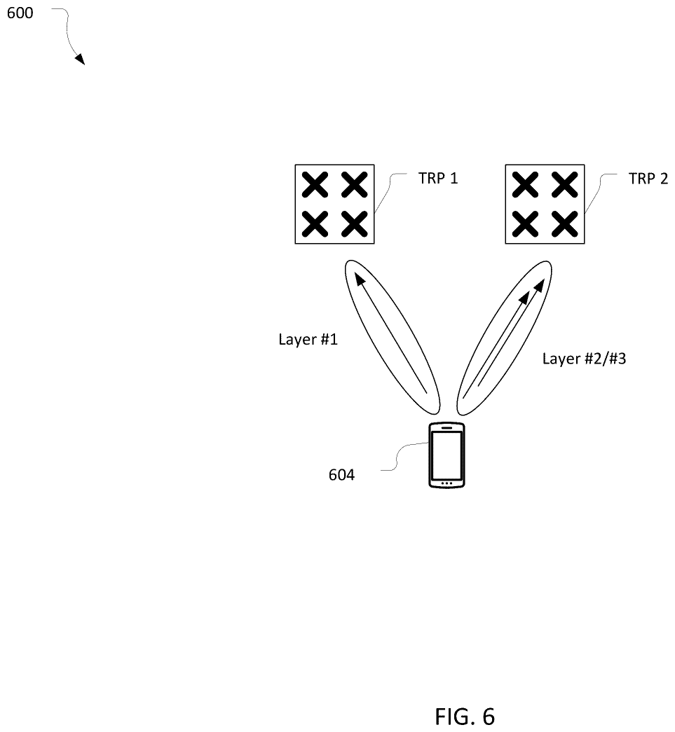

FIG. 6 illustrates a network environment 600 in which the UE 104 has multiple panels and is configured for STxMP in accordance with some embodiments. The UE 104 may be configured with a Type-2 CG PUSCH that is activated by DCI with three-layer, PUSCH STxMP operation over two panels. A first transmission layer (layer #1) may be associated with a first UL panel (e.g., panel #1) while second and third transmission layers (layer #2 and layer #3) may be associated with a second UL panel. Panel #1 may be associated with a first SRS resource set and a first TCI state, while panel #2 may be associated with a second SRS resource set and a second TCI state.

When switching from two-TCI states to one-TCI state, the UE 104 may operate based on one or more of the following options.

In a first option, the UE 104 may use the single unified TCI state for transmitting all the layers of the CG PUSCH transmission. For example, with reference to FIG. 6, after the UE 104 is updated to the single unified TCI state, the UE 104 may use the single unified TCI state (and its corresponding SRS resource set) for transmitting layers #1, #2, and #3.

In a second option, upon receipt of the one-state association, the UE 104 may determine that the Type 1 or Type 2 CG PUSCH configuration is implicitly disabled. In this instance, the UE 104 may not perform further transmission on the CG PUSCH resources further in anticipation of receiving an updated CG PUSCH configuration.

In a third option, the PUSCH layers associated with the second TCI state may be implicitly deactivated. For example, with reference to FIG. 6, the UE 104 may cease to transmit layer #2 and layer #3. Thus, in this embodiment, the UE 104 may assume the CG PUSCH is updated from a three-layer transmission to a one-layer transmission and may deactivate the layers associated with the TRP 2.

In some embodiments, fallback DCI (e.g., DCI format 0_0) may be used to activate a Type-2 CG PUSCH or schedule a retransmission of a CG PUSCH (either Type 1 or Type 2). In some embodiments, the CG PUSCH configuration may include two sets of power control parameters, which may be respectively associated with SRS resource sets. For example, the CG PUSCH configuration may include a first power control parameters (e.g., a p0-PUSCH-alpha (p0-PUSCH-Alpha) value used for open-loop power control and a power control loop to use (powerControlLooptoUse) value for closed-loop power control) for a first SRS resource set and second power control parameters (e.g., ap0-PUSCH-Alpha2 value and powerControlLooptoUse2 value) for a second SRS resource set. In the event the CG PUSCH configuration is configured, by RRC signaling, with two sets of power control parameters, one or more of the following options may be used.

In a first option, a single TCI state may be applied for all the PUSCH repetitions based on the corresponding SRS resource set. For example, the single TCI state that is used may be the first TCI state or the second TCI state. Whether to use the first or the second TCI states may be predetermined by, for example, definition in a 3GPP TS. Additionally/alternatively, whether the first or second TCI state is to be used may be explicitly configured by RRC signaling.

In a second option, the UE may apply two indicated TCI states, if present. If only one a single TCI state is indicated, the single TCI state may be applied similar to the first option.

In some instances, sDCI mTRP operation may be configured in which there are two SRS Resource Sets with a same usage (for example, both ‘codebook’ or both ‘nonCodebook’). In this event, the access node 116 may add an indicator IE in one or more SRS resource set configurations. The indicator IE may provide an indication of whether the UE 104 is to select the first unified TCI state or the second unified TCI state.

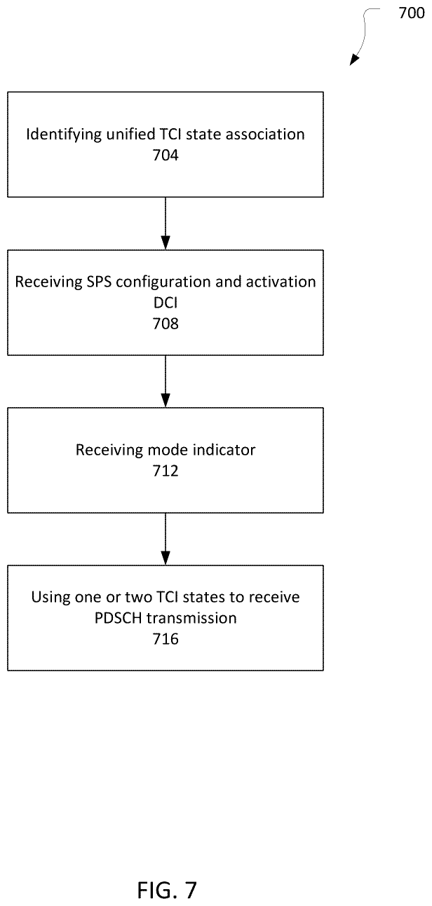

FIG. 7 illustrates an operational flow/algorithmic structure 700 for receiving PDSCH transmission based on SPS configuration in accordance with some embodiments. The operational flow/algorithmic structure 700 may be implemented by a UE such as, for example, UE 104, UE 1000, or components therein, for example, processors 1004.

The operational flow/algorithmic structure 700 may include, at 704, identifying a unified TCI state association. The unified TCI state association may be identified by receiving indication signaling that activates/indicates two TCI states with a PDSCH channel. The indication signaling may be MAC-CE-based signaling or MAC-CE+DCI-based signaling.

The operational flow/algorithmic structure 700 may further include, at 708, receiving an SPS configuration and activation DCI. The SPS configuration may configure resources that may be used for PDSCH channel. The activation DCI may subsequently be received to activate the resources. The DCI may include DCI format 1_0 or DCI 1_1.

The operational flow/algorithmic structure 700 may further include, at 712, receiving a mode indicator. The mode indicator may include one or two bits included in the SPS configuration or DCI. If the mode indicator is included in DCI format 1_0, the mode indicator may be provided by repurposing reserved bit(s). If the mode indicator is included in DCI format 1_1, the mode indicator may be provided by repurposing validation bits (e.g., from HARQ process number or RV field) or by a dedicated mode-indicator field.

The mode indicator may indicate whether the UE is to use the first unified TCI state to receive the PDSCH transmission, the second unified TCI state to receive the PDSCH transmission, or both unified TCI states to receive the PDSCH transmission.

The operational flow/algorithmic structure 700 may further include, at 716, receiving one or two TCI states to receive the PDSCH transmission. The UE may receive the PDSCH transmission using the unified TCI state or states as indicated by the mode indicator.

In some embodiments, the unified TCI state association may be updated from associating the PDSCH with two unified TCI states to one unified TCI state. Before the update, a first TCI state of the two unified TCI states may be associated with a first PDSCH occasion and a second TCI state of the two unified TCI states may be associated with a second PDSCH occasion. After the update, the one TCI state may be associated with both the first and second PDSCH occasions; or the one TCI states may be associated with the first PDSCH occasions and the second PDSCH occasions are disabled or released. Alternatively, after the update, the SPS PDSCH configuration may be deactivated or released.

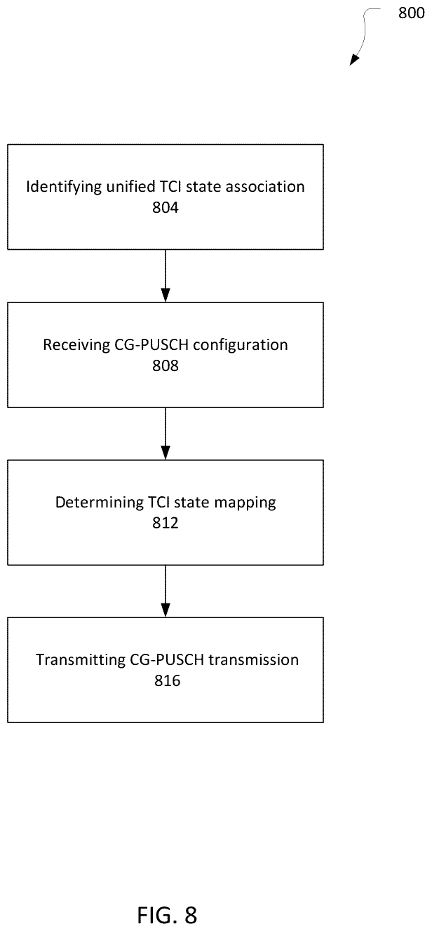

FIG. 8 illustrates an operational flow/algorithmic structure 800 for performing CG-PUSCH transmission in accordance with some embodiments. The operational flow/algorithmic structure 800 may be implemented by a UE such as, for example, UE 104, UE 1000, or components therein, for example, processors 1004.

The operational flow/algorithmic structure 800 may include, at 804, identifying a unified TCI state association. The unified TCI state association may be identified by receiving indication signaling that activates/indicates two TCI states with a CG-PUSCH. The indication signaling may be MAC-CE-based signaling or MAC-CE+DCI-based signaling.

The operational flow/algorithmic structure 800 may further include, at 808, receiving a CG-PUSCH configuration. The CG-PUSCH configuration may be for Type-1 CG or Type-2 CG.

The operational flow/algorithmic structure 800 may further include, at 812, determining a TCI state mapping. In some embodiments, the TCI state mapping may depend on whether the CG-PUSCH configuration includes fields to configure one SRS resource set or two SRS resource sets. If the configuration includes fields to configure two SRS resource sets, the TCI state mapping may map a first unified TCI state to a first PUSCH repetition and map the second unified TCI state to a second PUSCH repetition. If the configuration includes fields to configure one SRS resource set, the TCI state mapping may map the first unified TCI state to all PUSCH repetitions. In some embodiments selection of the first unified TCI state from two TCI states associated with the CG-PUSCH may be based on a mapping indicator in RRC signaling.

In some embodiments, activating DCI may include a mode indicator to indicate an uplink operating mode. The UE may determine the TCI state mapping based on the uplink operating mode. The uplink operating mode may be a first sTRP mode in which the first unified TCI state is to be used to transmit the CG-PUSCH; a second sTRP mode in which the second unified TCI state is to be used to transmit the CG-PUSCH; a first mTRP mode in which the first unified TCI state is used to transmit a first repetition of the CG-PUSCH transmission and the second unified TCI state is used to transmit a second repetition of the CG-PUSCH transmission after the transmission of the first repetition; or a second mTRP mode in which the second unified TCI state is used to transmit a first repetition of the CG-PUSCH transmission and the first unified TCI state is used to transmit a second repetition of the CG-PUSCH transmission after the transmission of the first repetition.

The operational flow/algorithmic structure 800 may further include, at 816, transmitting a CG-PUSCH transmission. The transmission of the CG-PUSCH transmission may be based on the configuration and the TCI state mapping.

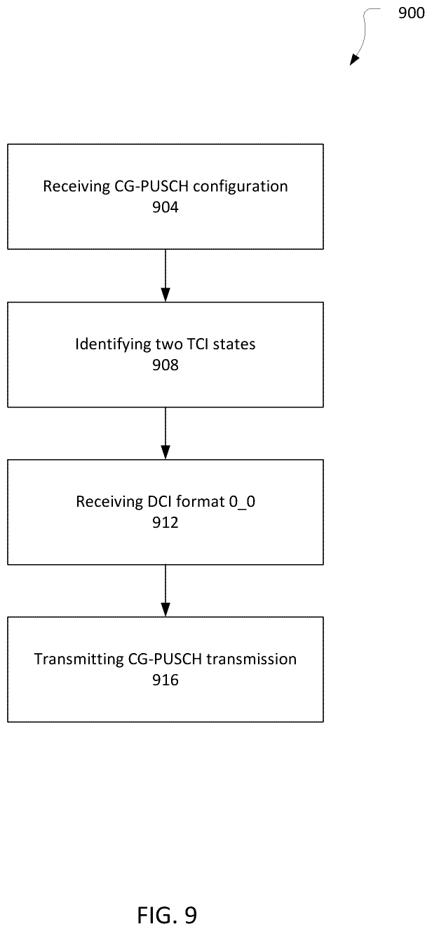

FIG. 9 illustrates an operational flow/algorithmic structure 900 for transmitting CG-PUSCH transmissions in accordance with some embodiments. The operational flow/algorithmic structure 900 may be implemented by a UE such as, for example, UE 104 or 1000 or components therein, for example, processors 1004.

The operational flow/algorithmic structure 900 may include, at 904, receiving a CG-PUSCH configuration. The CG-PUSCH configuration may have a first set of power control parameters associated with the first SRS resource set and a second set of power control parameters associated with the second SRS resource set. The power control parameters may include a p0-PUSCH-alpha value for open-loop power control and a power-control-loop-to-use value for closed-loop power control.

The operational flow/algorithmic structure 900 may further include, at 908, identifying two TCI states associated with the CG-PUSCH configuration. The two TCI states may be identified by receiving indication signaling that associates the two TCI states with the CG-PUSCH. The indication signaling may be MAC-CE-based signaling or MAC-CE+DCI-based signaling.

The operational flow/algorithmic structure 900 may further include, at 912, receiving DCI format 0_0 associated with the CG-PUSCH configuration. This DCI may be fallback DCI that activates a Type-2 CG PUSCH or schedules a retransmission of a Type-1 or Type-2 CG PUSCH.

The operational flow/algorithmic structure 900 may further include, at 916, transmitting a CG-PUSCH transmission using one or more of the two unified TCI states. This may be based on the DCI format 0_0 and the CG-PUSCH configuration.

In some embodiments, the UE may select a first TCI state from the two TCI states based on a preconfigured setting in, e.g., a 3GPP TS, or based on RRC signaling. The CG-PUSCH transmission may be transmitted using the first TCI state.

In some embodiments, if first and second SRS resource sets are both configured with a codebook usage or are both configured with a non-codebook usage, the UE may detect an indicator IE of a SRS resource set configuration and selecting a first TCI state from the two TCI states based on the indicator IE. The first TCI state may then be used for the CG-PUSCH transmission.

In some embodiments, the UE may transmit the CG-PUSCH transmission using both of the two unified TCI states.

Some embodiments include operational flows/algorithmic structures that complement operational flows/algorithmic structures 700, 800, and 900 from the perspective of the network. For example, an access node such as access node 116, network node 1100, or components therein, for example, processors 1104 may implement such operational flows/algorithmic structures to configure a UE for UL/DL transmissions, transmit DL transmissions, and receive UL transmissions as described herein.

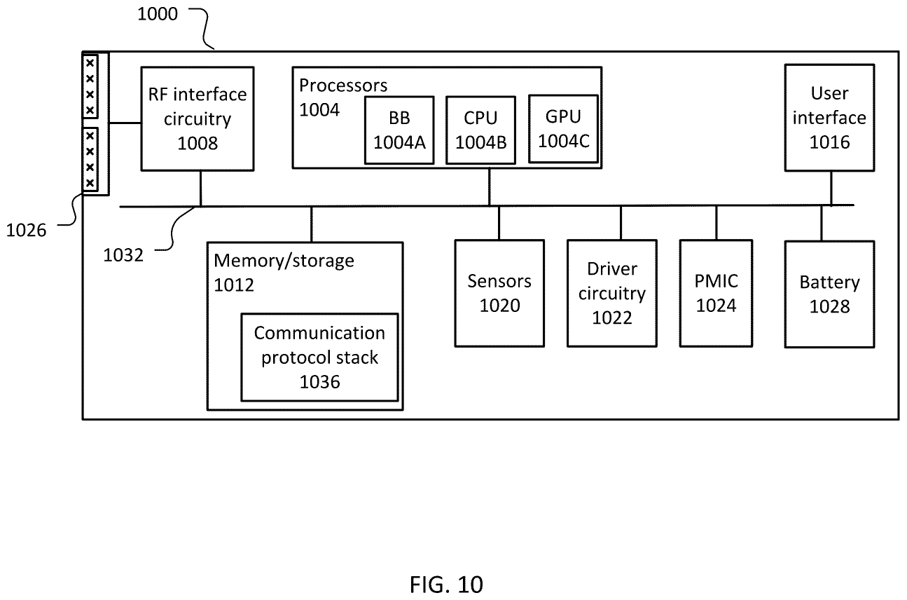

FIG. 10 illustrates a UE 1000 in accordance with some embodiments. The UE 1000 may be similar to and substantially interchangeable with UE 104 of FIG. 1.

The UE 1000 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various sTRP/mTRP operations as described herein. For example, the processors 1004 may cause the UE to perform the operational flow/algorithmic structure 700, 800, 900, or any other method or process describe herein.

The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1026.

In various embodiments, the RF interface circuitry 1008 may be configured to transmit/receive signals in a manner compatible with NR access technologies.

The antenna structure 1026 may include antenna elements to convert electrical signals into radio waves to travel through the air and to convert received radio waves into electrical signals. The antenna elements may be arranged into one or more antenna panels. The antenna structure 1026 may have antenna panels that are omnidirectional, directional, or a combination thereof to enable beamforming and multiple input, multiple output communications. The antenna structure 1026 may include microstrip antennas, printed antennas fabricated on the surface of one or more printed circuit boards, patch antennas, or phased array antennas. The antenna structure 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various I/O devices that may be present within, or connected to, the UE 1000. For example, the driver circuitry 1022 may include circuitry to facilitate coupling of a UICC to the UE 1000. For additional examples, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000 including DRX as discussed herein.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

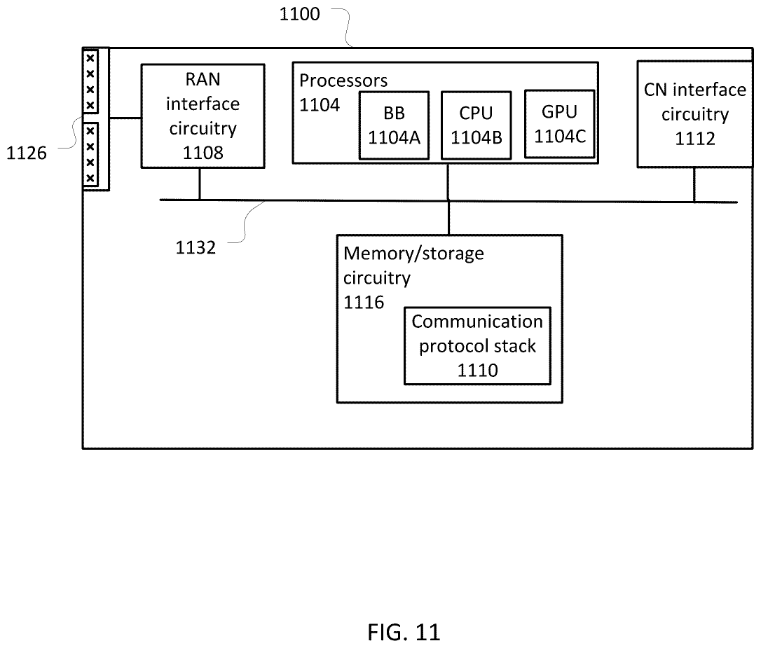

FIG. 11 illustrates a network node 1100 in accordance with some embodiments. The network node 1100 may be similar to and substantially interchangeable with access node 116 or base station 108.

The network node 1100 may include processors 1104, RF interface circuitry 1108 (if implemented as an access node), core network (CN) interface circuitry 1112, memory/storage 1116, and antenna structure 1126.

The components of the network node 1100 may be coupled with various other components over one or more interconnects 1132.

The processors 1104, RF interface circuitry 1108, memory/storage 1116 (including communication protocol stack 1110), antenna structure 1126, and interconnects 1132 may be similar to like-named elements shown and described with respect to FIG. 10.

The memory/storage 1116 may include one or more non-transitory, computer-readable media that includes instructions (for example, communication protocol stack 1110) that may be executed by one or more of the processors 1104 to cause the network node 1100 to perform configuration and sTRP/mTRP operations as described herein. For example, the processors 1104 may cause the network node 1100 to perform the operational flow/algorithmic structures that complement operational flow/algorithmic structures 700, 800, or 900, or any other method or process described herein.

The CN interface circuitry 1112 may provide connectivity to a core network, for example, a 5th Generation Core network (5GC) using a 5GC-compatible network interface protocol such as carrier Ethernet protocols, or some other suitable protocol. Network connectivity may be provided to/from the network node 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

In some embodiments, the network node 1100 may be coupled with transmit receive points (TRPs) using the antenna structure 1126, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.

Example 1 includes method of operating a user equipment (UE), the method comprising: identifying a unified transmission configuration indicator (TCI) state association that associates two unified TCI states with a physical downlink shared channel (PDSCH); receiving a semi-persistent scheduling (SPS) configuration; receiving downlink control information (DCI) to activate the SPS configuration; receiving a mode indicator; and using at least one unified TCI state of the two unified TCI states to receive a PDSCH transmission based on the SPS configuration and the mode indicator.

Example 2 includes the method of example 1 or some other example herein, further comprising: receiving the mode indicator in the SPS configuration by radio resource control (RRC) signaling.

Example 3 includes a method of example 1 or some other example herein, further comprising: receiving the mode indicator in the DCI.

Example 4 includes the method of example 3 or some other example herein, wherein the DCI comprise DCI format 1_1 and the mode indicator is two bits in a mode indicator field.

Example 5 includes the method of example 3 or some other example herein, wherein the mode indicator comprises two bits in a repurposed field of validation bits the DCI.

Example 6 includes the method of example 1 or some other example herein, wherein the mode indicator is to indicate the UE is to use the first unified TCI state to receive the PDSCH transmission, the second unified TCI state to receive the PDSCH transmission, or both the first unified TCI state and the second unified TCI state to receive a plurality of repetitions of the PDSCH transmission.

Example 7 includes the method of example 1 or some other example herein, wherein the PDSCH is semi-persistent scheduling (SPS) PDSCH and the method further comprises: determining the unified TCI state association is updated to associate one unified TCI state with the PDSCH.

Example 8 includes a method of example 7 or some other example herein, further comprising: when the unified TCI state association associates two unified TCI states with the SPS PDSCH, associating a first unified TCI state of the two unified TCI states with a first SPS PDSCH occasion and associating a second unified TCI state of the two unified TCI states with a second SPS PDSCH occasion; and when the unified TCI state association associates one unified TCI state with the PDSCH, associating the one unified TCI state with the first SPS PDSCH occasion and the second SPS PDSCH occasion.

Example 9 includes the method of example 7 or some other example herein, further comprising: when the unified TCI state association associates two unified TCI states with the SPS PDSCH, associating a first unified TCI state of the two unified TCI states with a first SPS PDSCH occasion and associating a second unified TCI state of the two unified TCI states with a second SPS PDSCH occasion; and when the unified TCI state association associates one unified TCI state with the PDSCH, associating the one unified TCI state with the first SPS PDSCH occasion and disabling or releasing the second SPS PDSCH occasion.

Example 10 includes the method of example 8 or 9 or some other example herein, wherein: the SPS PDSCH uses spatial division multiplexing and the first SPS PDSCH occasion corresponds to a first one or more antenna ports and the second SPS PDSCH occasion corresponds to a second one or more antenna ports; the SPS PDSCH uses frequency division multiplexing and the first SPS PDSCH occasion corresponds to a first one or more resource blocks and the second SPS PDSCH occasion corresponds to a second one or more resource blocks; and the SPS PDSCH uses time division multiplexing and the first SPS PDSCH occasion corresponds to a first one or more reception occasions and the second SPS PDSCH occasion corresponds to a second one or more reception occasions.

Example 11 includes a method of example 7 or some other example herein, further comprising: deactivating or releasing the SPS configuration based on determining the unified TCI state association is updated to associate one unified TCI state with the PDSCH.

Example 12 includes a method of operating a base station, the method comprising: transmitting, to a user equipment (UE), a unified transmission configuration indicator (TCI) state association that associates two unified TCI states with a physical downlink shared channel (PDSCH); transmitting, to the UE, a semi-persistent scheduling (SPS) configuration; transmitting, to the UE, downlink control information (DCI) to activate the SPS configuration; and transmitting, to the UE, a mode indicator to indicate the UE is to use at least one unified TCI state of the two unified TCI states to receive a PDSCH transmission.

Example 13 includes the method of example 12 or some other example herein, further comprising: transmitting the mode indicator in the SPS configuration by radio resource control (RRC) signaling.

Example 14 includes a method of example 12 or some other example herein, further comprising: transmitting the mode indicator in the DCI.

Example 15 includes the method of example 14 or some other example herein, wherein the DCI comprise DCI format 1_1 and the mode indicator is two bits in a mode indicator field.

Example 16 includes a method of example 12 or some other example herein, wherein the mode indicator is to indicate the UE is to use the first unified TCI state to receive the PDSCH transmission, the second unified TCI state to receive the PDSCH transmission, or both the first unified TCI state and the second unified TCI state to receive a plurality of repetitions of the PDSCH transmission.

Example 17 includes a method of operating a user equipment (UE), the method comprising: identifying a unified transmission configuration indicator (TCI) state association that associates two unified TCI states with a physical uplink shared channel (PUSCH); receiving a configured grant (CG)-PUSCH configuration; determining a TCI state mapping; and transmitting a CG-PUSCH transmission using a first unified TCI state of the two unified TCI states or a second unified TCI state of the two unified TCI states based on the CG-PUSCH configuration and the TCI state mapping.

Example 18 includes the method of example 17 or some other example herein, further comprising: determining whether the CG-PUSCH configuration includes a plurality of fields to configure one or two sounding reference signal (SRS) resource sets, wherein individual fields of the plurality of fields comprise a pathloss reference index field, an SRS resource indicator field, and a precoding and number of layers field; determining the TCI state mapping based on determining whether the CG-PUSCH configuration includes the plurality of fields to configure one or two SRS resource sets.

Example 19 includes the method of example 18 or some other example herein, wherein the plurality of fields are to configure two SRS resource sets and the method further comprises: determining the TCI state mapping maps a first unified TCI state of the two unified TCI states to a first PUSCH repetition of the CG-PUSCH transmission and maps a second unified TCI state of the two unified TCI states to a second PUSCH repetition of the CG-PUSCH transmission.

Example 20 includes a method of example 18 or some other example herein, wherein the plurality of fields are to configure one SRS resource set and the method further comprises: determining the TCI state mapping maps a first unified TCI state of the two unified TCI states to all PUSCH repetitions of the CG-PUSCH transmission.

Example 21 includes the method of example 20 or some other example herein, further comprising: receiving a mapping indicator in radio resource control (RRC) signaling; and selecting the first unified TCI state from the two unified TCI states based on the mapping indicator.

Example 22 includes a method of example 17 or some other example herein, wherein the CG-PUSCH configuration is a type-2 CG PUSCH configuration and the method further comprises: receiving a media access control (MAC) control element (CE) that includes a first unified TCI state of the two unified TCI states and a second unified TCI state of the two unified TCI states, wherein the first unified TCI state is earlier in the MAC CE than the second unified TCI state; and receiving a DCI to activate the type-2 CG PUSCH, the DCI to include a mode indicator to indicate an uplink operating mode; and determining the TCI state mapping based on the uplink operating mode.

Example 23 includes a method of example 22 or some other example herein, wherein the uplink operating mode is a single TRP mode in which the first unified TCI state is to be used to transmit the CG-PUSCH transmission; a single TRP mode in which the second unified TCI state is to be used to transmit the CG-PUSCH transmission; a multi-TRP mode in which the first unified TCI state is used to transmit a first repetition of the CG-PUSCH transmission and the second unified TCI state is used to transmit a second repetition of the CG-PUSCH transmission after the transmission of the first repetition; or a multi-TRP mode in which the second unified TCI state is used to transmit a first repetition of the CG-PUSCH transmission and the first unified TCI state is used to transmit a second repetition of the CG-PUSCH transmission after the transmission of the first repetition.

Example 24 includes a method of example 17 or some other example herein, determining the unified TCI state association is updated to associate one unified TCI state with the PUSCH.

Example 25 includes a method of example 24 some other example herein, further comprising: when the unified TCI state association associates two unified TCI states with the PUSCH, associating a first unified TCI state of the two unified TCI states with a first CG-PUSCH layer and associating a second unified TCI state of the two unified TCI states with a second CG-PUSCH layer; and when the unified TCI state association associates one unified TCI state with the PUSCH, associating the one unified TCI state with the first CG-PUSCH layer and the second CG-PUSCH layer.

Example 26 includes the method of example 24 some other example herein, further comprising: when the unified TCI state association associates two unified TCI states with the PUSCH, associating a first unified TCI state of the two unified TCI states with a first CG-PUSCH layer and associating a second unified TCI state of the two unified TCI states with a second CG-PUSCH layer; and when the unified TCI state association associates one unified TCI state with the PUSCH, associating the one unified TCI state with the first CG-PUSCH layer and disabling or releasing the second CG-PUSCH layer.

Example 27 includes a method of example 24 some other example herein, further comprising: deactivating or releasing the CG-PUSCH configuration based on determining the unified TCI state association is updated to associate one unified TCI state with the PUSCH.

Example 28 includes a method of operating a user equipment (UE), the method comprising: receiving a configured grant (CG)-physical uplink shared channel (PUSCH) configuration with a first set of power control parameters associated with a first sounding reference signal (SRS) resource set and a second set of power control parameters associated with a second SRS resource set; identifying two unified transmission configuration indicator (TCI) states associated with the CG-PUSCH configuration; receiving downlink control information (DCI) format 0_0 associated with the CG-PUSCH configuration; and transmitting, based on the DCI format 0_0 and the CG-PUSCH configuration, a CG-PUSCH transmission using one or more of the two unified TCI states.

Example 29 includes the method of example 28 or some other example herein, further comprising: selecting a first TCI state from the two TCI states based on a preconfigured setting or radio resource control signaling; and transmitting the CG-PUSCH transmission using the first TCI state.

Example 30 includes a method of example 28 or some other example herein, further comprising: transmitting the CG-PUSCH transmission using both of the two unified TCI states.

Example 31 includes a method of example 28 or some other example herein, wherein the first set of power control parameters includes a first p0-PUSCH-alpha value and a first power-control-loop-to-use value and the second set of power control parameters includes a second p0-PUSCH-alpha value and a second power-control-loop-to-use value.

Example 32 includes a method of example 28 or some other example herein, wherein the first SRS resource set and the second SRS resource set are both configured with a codebook usage or are both configured with a non-codebook usage and the method further comprises: detecting an indicator information element of a SRS resource set configuration; and selecting a first TCI state from the two TCI states based on the indicator information element.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example includes a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify a unified transmission configuration indicator (TCI) state association that associates two unified TCI states with a physical downlink shared channel (PDSCH);
receive a semi-persistent scheduling (SPS) configuration;
receive downlink control information (DCI) to activate the SPS configuration;
receive a mode indicator; and
use at least one unified TCI state of the two unified TCI states to receive a PDSCH transmission based on the SPS configuration and the mode indicator.

2. The one or more non-transitory, computer-readable media of claim 1, wherein the instructions, when executed, further cause the processing circuitry to:
receive the mode indicator in the SPS configuration by radio resource control (RRC) signaling; or
receive the mode indicator in the DCI having a DCI format 1_1 and the mode indicator is two bits in a mode indicator field, or the mode indicator comprises two bits in a repurposed field of validation bits the DCI.

3. The one or more non-transitory, computer-readable media of claim 1, wherein the two unified TCI states include a first unified TCI state and a second unified TCI state and the mode indicator is to indicate the UE is to use the first unified TCI state to receive the PDSCH transmission, the second unified TCI state to receive the PDSCH transmission, or both the first unified TCI state and the second unified TCI state to receive a plurality of repetitions of the PDSCH transmission.

4. The one or more non-transitory, computer-readable media of claim 1, wherein the PDSCH is semi-persistent scheduling (SPS) PDSCH and the instructions, when executed, further cause the processing circuitry to:
determine the unified TCI state association is updated to associate one unified TCI state with the PDSCH.

5. The one or more non-transitory, computer-readable media of claim 4, wherein the instructions, when executed, further cause the processing circuitry to:
when the unified TCI state association associates two unified TCI states with the SPS PDSCH, associate a first unified TCI state of the two unified TCI states with a first SPS PDSCH occasion and associating a second unified TCI state of the two unified TCI states with a second SPS PDSCH occasion; and
when the unified TCI state association associates one unified TCI state with the PDSCH, associate the one unified TCI state with the first SPS PDSCH occasion and the second SPS PDSCH occasion.

6. The one or more non-transitory, computer-readable media of claim 4, wherein the instructions, when executed, further cause the processing circuitry to:
when the unified TCI state association associates two unified TCI states with the SPS PDSCH, associate a first unified TCI state of the two unified TCI states with a first SPS PDSCH occasion and associating a second unified TCI state of the two unified TCI states with a second SPS PDSCH occasion; and
when the unified TCI state association associates one unified TCI state with the PDSCH, associate the one unified TCI state with the first SPS PDSCH occasion and disabling or releasing the second SPS PDSCH occasion.

7. The one or more non-transitory, computer-readable media of claim 5 or 6, wherein:
the SPS PDSCH uses spatial division multiplexing and the first SPS PDSCH occasion corresponds to a first one or more antenna ports and the second SPS PDSCH occasion corresponds to a second one or more antenna ports;
the SPS PDSCH uses frequency division multiplexing and the first SPS PDSCH occasion corresponds to a first one or more resource blocks and the second SPS PDSCH occasion corresponds to a second one or more resource blocks; and
the SPS PDSCH uses time division multiplexing and the first SPS PDSCH occasion corresponds to a first one or more reception occasions and the second SPS PDSCH occasion corresponds to a second one or more reception occasions.

8. The one or more non-transitory, computer-readable media of claim 4, wherein the instructions, when executed, further cause the processing circuitry to:
deactivate or release the SPS configuration based on determination the unified TCI state association is updated to associate one unified TCI state with the PDSCH.

9. A method comprising:
transmitting, to a user equipment (UE), a unified transmission configuration indicator (TCI) state association that associates two unified TCI states with a physical downlink shared channel (PDSCH);
transmitting, to the UE, a semi-persistent scheduling (SPS) configuration;
transmitting, to the UE, downlink control information (DCI) to activate the SPS configuration; and
transmitting, to the UE, a mode indicator to indicate the UE is to use at least one unified TCI state of the two unified TCI states to receive a PDSCH transmission.

10. The method of claim 9, further comprising:
transmitting the mode indicator in the SPS configuration by radio resource control (RRC) signaling; or
transmitting the mode indicator in the DCI, wherein the DCI comprise DCI format 1_1 and the mode indicator is two bits in a mode indicator field.

11. The method of claim 9, wherein the two unified TCI states include a first unified TCI state and a second unified TCI state and the mode indicator is to indicate the UE is to use the first unified TCI state to receive the PDSCH transmission, the second unified TCI state to receive the PDSCH transmission, or both the first unified TCI state and the second unified TCI state to receive a plurality of repetitions of the PDSCH transmission.

12. An apparatus comprising:
processing circuitry configured to:
identify a unified transmission configuration indicator (TCI) state association that associates two unified TCI states with a physical uplink shared channel (PUSCH);
receive a configured grant (CG)-PUSCH configuration;
determine a TCI state mapping; and
generate a CG-PUSCH transmission using a first unified TCI state of the two unified TCI states or a second unified TCI state of the two unified TCI states based on the CG-PUSCH configuration and the TCI state mapping; and
interface circuitry coupled with the processing circuitry, the interface circuitry to communicatively couple the processing circuitry with a component of a device.

13. The apparatus of claim 12, wherein the processing circuitry is further configured to:
determine whether the CG-PUSCH configuration includes a plurality of fields to configure one or two sounding reference signal (SRS) resource sets, wherein individual fields of the plurality of fields comprise a pathloss reference index field, an SRS resource indicator field, and a precoding and number of layers field; and
determine the TCI state mapping based on determination of whether the CG-PUSCH configuration includes the plurality of fields to configure one or two SRS resource sets.

14. The apparatus of claim 13, wherein the plurality of fields are to configure two SRS resource sets and the processing circuitry is further configured to:
determine the TCI state mapping maps a first unified TCI state of the two unified TCI states to a first PUSCH repetition of the CG-PUSCH transmission and maps a second unified TCI state of the two unified TCI states to a second PUSCH repetition of the CG-PUSCH transmission.

15. The apparatus of claim 13, wherein the plurality of fields are to configure one SRS resource set and the processing circuitry is further configured to:
determine the TCI state mapping maps a first unified TCI state of the two unified TCI states to all PUSCH repetitions of the CG-PUSCH transmission;
receive a mapping indicator in radio resource control (RRC) signaling; and
select the first unified TCI state from the two unified TCI states based on the mapping indicator.

16. The apparatus of claim 12, wherein the CG-PUSCH configuration is a type-2 CG PUSCH configuration and the processing circuitry is further configured to:
receive a media access control (MAC) control element (CE) that includes a first unified TCI state of the two unified TCI states and a second unified TCI state of the two unified TCI states, wherein the first unified TCI state is earlier in the MAC CE than the second unified TCI state;
receive a DCI to activate the type-2 CG PUSCH, the DCI to include a mode indicator to indicate an uplink operating mode; and
determine the TCI state mapping based on the uplink operating mode.

17. The apparatus of claim 16, wherein the uplink operating mode is a single TRP mode in which the first unified TCI state is to be used to transmit the CG-PUSCH transmission; a single TRP mode in which the second unified TCI state is to be used to transmit the CG-PUSCH transmission; a multi-TRP mode in which the first unified TCI state is used to transmit a first repetition of the CG-PUSCH transmission and the second unified TCI state is used to transmit a second repetition of the CG-PUSCH transmission after the transmission of the first repetition; or a multi-TRP mode in which the second unified TCI state is used to transmit a first repetition of the CG-PUSCH transmission and the first unified TCI state is used to transmit a second repetition of the CG-PUSCH transmission after the transmission of the first repetition.

18. The apparatus of claim 12, wherein the processing circuitry is further configured to:
when the unified TCI state association associates two unified TCI states with the PUSCH, associate a first unified TCI state of the two unified TCI states with a first CG-PUSCH layer and associating a second unified TCI state of the two unified TCI states with a second CG-PUSCH layer; and
when the unified TCI state association associates one unified TCI state with the PUSCH, associate the one unified TCI state with the first CG-PUSCH layer and the second CG-PUSCH layer.

19. The apparatus of claim 12, wherein the processing circuitry is further configured to:
when the unified TCI state association associates two unified TCI states with the PUSCH, associate a first unified TCI state of the two unified TCI states with a first CG-PUSCH layer and associating a second unified TCI state of the two unified TCI states with a second CG-PUSCH layer; and
when the unified TCI state association associates one unified TCI state with the PUSCH, associate the one unified TCI state with the first CG-PUSCH layer and disable or release the second CG-PUSCH layer.

20. The apparatus of claim 12, wherein the processing circuitry is further to:
deactivate or release the CG-PUSCH configuration based on a determination the unified TCI state association is updated to associate one unified TCI state with the PUSCH.
